(19) United States
(12) Patent Application Publication
(10) Pub. No.: US 2008/0244251 A1
(43) Pub. Date: Oct. 2, 2008

(54) PREDICTIVE MODEL IMPLEMENTATION SYSTEM AND METHODOLOGY

(75) Inventors: Dale Bryan Fletcher, Hamilton (NZ); Anthony John Greaves, Cambridge (NZ); Geoffrey Holmes, Ohaupo (NZ)

Correspondence Address: KREMBLAS, FOSTER, PHILLIPS & POLLICK, 7632 SLATE RIDGE BOULEVARD, REYNOLDSBURG, OH, 43068, US

(73) Assignee: KHIPU SYSTEMS LIMITED, Hamilton (NZ)

(21) Appl. No.: 11/870,706

(22) Filed: Oct. 11, 2007

(30) Foreign Application Priority Data
Mar. 29, 2007 (NZ) 554258

(51) Int. Cl. G06F 9/00

(52) U.S. Cl. 713/1

(57) ABSTRACT

The invention relates to a methodology and computer executable instructions configured to implement a prediction system. The invention deals with the use of a configuration file specifying at least the interactions to be completed between components of the prediction system, where this configuration file is transmitted to an implementation site. At the implementation site the configuration file is supplied as an input to at least one autonomous software agent where this agent or agents run the components of the prediction system as specified by the interactions defined within the configuration file. An extension to this method is also disclosed where the prediction system is built or constructed at the implementation site using the configuration file.

This application claims foreign priority benefits under 35 U.S.C. 119(a)-(d) or (f) of application number 554258 filed in New Zealand on 29 Mar. 2007 which is herein incorporated by reference.

### TECHNICAL FIELD

This invention relates to a system and methodology employed to implement at least one predictive model. Preferably the present invention may employ autonomous software agents at a user site to implement one or more predictive models when supplied with an initialisation configuration.

### BACKGROUND ART

Predictive models have been developed which employ mathematical techniques to establish a relationship between input predictive variables and a required output characteristic to be predicted.

A range of machine learning and statistical techniques can be said to fall within the field of predictive modelling, all of which require an input data set to establish a relationship between predictive variables and the output characteristic of interest.

Such predictive models can provide useful tools in a wide range of applications. For example, in the chemical analysis field a near infrared (NIR) absorption spectrum of (for example) a milk sample can provide input data for a predictive model to predict fat or protein content. Such fat or protein predictions may be confirmed through independent chemical analysis, thereby validating the performance of such models or providing the data required to establish the relationship used by the model. In other instances such predictive models may be employed (for example) in marketing applications to forecast the possibility of success of particular marketing campaigns using different forms of advertising media to reach selected consumer demographics.

For the case of chemical analysis work, for example, such predictive models can mitigate the need to complete large numbers of time consuming and costly individual analysis tests, as could be the case for industrial quality control or quality assurance protocols.

However, the utilisation of such predictive models is presently limited by the technical expertise required to develop and maintain these models. Experts in the domain or field in which the model is to be deployed are currently required to structure the data sets employed, to specify the mathematical treatment of such data sets, to use appropriate mathematical software to build new models and to test and monitor the performance of such models once implemented.

These processes are necessarily time consuming and in a number of instances require a domain expert to be located on site to have access to the data that is captured and stored there.

These expertise requirements are a current bottleneck in the wide spread implementation and use of such predictive models.

It would therefore be preferable to have available a semi-automated or automated system or methodology which addressed such expertise limitations. In particular it would be preferable to have a system available which could be configured to run autonomously at an end user's site to construct and maintain one or more predictive models without the intervention of expert personnel.

It is an object of the present invention to address the foregoing problems or at least to provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinence of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components. This rationale will also be used when the term ‘comprised’ or ‘comprising’ is used in relation to one or more steps in a method or process.

Further aspects and advantages of the present invention will become apparent from the ensuing description which is given by way of example only.

### DISCLOSURE OF INVENTION

According to one aspect of the present invention there is provided a method of implementing a prediction system characterised by the steps of;
i) preparing a configuration file, said configuration file specifying interactions to be completed between components of a prediction system, and
ii) transmitting said configuration file to an implementation site, and
iii) supplying the configuration file as an input to at least one autonomous software agent, wherein said agent or agents run the components of a prediction system as specified by the interactions defined within said configuration file.

According to a further aspect of the present invention there is provided a method of implementing a prediction system characterised by the steps of;
i) preparing a configuration file, said configuration file specifying the components of the prediction system to be implemented, and
ii) transmitting said configuration file to an implementation site, and
iii) supplying the configuration file as an input to at least one autonomous software agent, wherein said agent or agents build the components of the prediction system specified within the configuration file.

According to another aspect of the present invention there is provided a method of implementing a prediction system substantially as described above wherein said at least one autonomous software agent is also supplied with data provided from at least one data source to build at least one predictive model.

According to yet another aspect of the present invention there is provided computer executable instructions configured to implement a prediction system at an implementation site, said instructions being configured to execute the steps of;
i) receiving a configuration file, said configuration file specifying interactions to be completed between components of a prediction system, and
ii) gathering data from at least one data source, and
iii) running the components of the prediction system as specified by the interactions defined within the configuration file using at least one autonomous software agent supplied with said gathered data.

According to a further aspect of the present invention there is provided computer executable instructions configured to implement a prediction system at an implementation site, said instructions being configured to execute the steps of;
i) receiving a configuration file, said configuration file specifying the components of the prediction system to be implemented, and
ii) gathering data from at least one data source, and
iii) building the components of the prediction system specified within the configuration file, wherein data received from at least one data source is used to build at least one predictive model.

According to a further aspect of the present invention there is provided a method of implementing a prediction system and computer executable instructions which facilitate same as described above, wherein the configuration file specifies the components of the prediction system to be implemented and defines interactions to be completed between the components of the prediction system.

According to yet another aspect of the present invention there is provided a method of implementing a prediction system and computer executable instructions which facilitate same as described above wherein components of the prediction system to be implemented can include but are not limited to any combination of;
at least one data input interface, and/or
at least one prediction output interface, and/or
at least one predictive model, and/or
at least one performance monitoring component.

The present invention is adapted to facilitate the provision or implementation of prediction systems at specific implementation sites, which may be linked to one another through communication networks. The present invention encompasses both a methodology for implementing such prediction systems, in addition to computer executable instructions that run on a computer system to facilitate the implementation of such a prediction system. Furthermore, the present invention also encompasses such prediction systems themselves, preferably formed through computer executable instructions run on an appropriate computer system or systems.

Reference in general has been made to the present invention providing or facilitating a method of implementing and running a prediction system. However, those skilled in the art should appreciate that such computer executable instructions as well as apparatus provided or implemented through such instructions are also within the scope of the present invention.

The present invention initially employs a configuration file which provides information in a digital format which may be stored using computer readable media or transmitted using a data transmission network. Such a configuration file can be prepared by or with the assistance of an expert to specify all the components which need to be implemented to provide the prediction system.

Reference in the main throughout this specification will be made to a configuration file being transmitted to an implementation site, and a prediction system subsequently being built at this implementation site based on the components of the prediction system specified within the configuration file. However, those skilled in the art should appreciate that alternative distribution architectures may also be employed in conjunction with the present invention.

For example, in one alternative embodiment an entire or partially built prediction system may be transmitted to an implementation site in combination with a configuration file which defines the interactions to be completed between the components of this complete or partially complete prediction system. Those skilled in the art should appreciate that such a configuration file may be employed to guide the building of a prediction system and/or manage the operation of a previously constructed prediction system.

Preferably, such a configuration file may provide a description of the overall prediction system to be implemented. A configuration file may also specify or describe how the components of the prediction system interact with each other to effect its operation. Such interactions as defined or described by the configuration file may specify messages, requests, commands or data to be passed between components when the prediction system is in operation.

Preferably the present invention may employ a single configuration file to implement a single prediction system. A single continuous or concurrent file may be employed to embed all of the information required to implement and operate a prediction system. However, those skilled in the art should appreciate that multiple configuration files may be provided to implement a single prediction system if required and reference to the use of a single configuration file throughout this specification should in no way be seen as limiting.

In a preferred embodiment a digital signature may be supplied in association with the configuration file. A digital signature may be prepared using known public/private key encryption systems to both detect any tampering which has occurred since the author prepared the configuration file, in addition to confirming the identity of this author. Such digital signatures may in some instances be embedded directly within a configuration file, or in other embodiments may be supplied separate from but potentially at the same time as a configuration file. In a further preferred embodiment where a configuration file is prepared using XML formatting of information, a W3C XML scheme may be used in association with a configuration file.

The present invention can be employed to facilitate the implementation of a prediction system at an implementation site, which need not necessarily be the same location as that of the expert tasked with preparing a configuration file. Preferably such digitalised computer readable configuration files may be transmitted to an implementation site, either through the use of digital data transmission networks or the physical transfer of computer readable media such as compact discs or DVDs. Such implementation sites may house or provide localised access to data sources required to implement and actually operate the prediction system provided.

The methodology of the present invention eliminates the need for the actual attendance of the expert who prepared the configuration file at the implementation site. The present invention may also dispense with any future need for such an expert to visit the implementation site to monitor and potentially modify the prediction system in some instances.

Preferably the present invention employs or provides at least one autonomous software agent that receives the transmitted configuration file as an input at the implementation site. Such an autonomous agent or agents can be used to execute the design specification of the prediction system outlined within the configuration file. Furthermore, such software agents may also be employed to run or operate the prediction system once implemented, and in some embodiments may also manage feedback processes which test the accuracy of the output of the prediction systems based on actual corresponding measurements.

An autonomous software agent is well suited for use with the present invention. An appropriate autonomous software agent may be provided with a goal orientated focus, to be achieved through a set of steps required to implement the prediction system in addition to subsequently running or operating, and improving the prediction system. Such an agent or agents may react to their environment autonomously through the supply of inputs to the prediction system to pursue the goals set for them. In some embodiments such goals may be implicit in the overall configuration of the system. In other embodiments such goals may be explicit, for instance taking the form of parameter values supplied to goal-seeking elements. An example might be in the use of agents each set the explicit goal of reaching a target level of accuracy for a particular predictive model.

Further details with respect to the general characteristics of such autonomous software agents are provided by Franklin and Graesser which is incorporated herein by way of reference (Stan Franklin and Art Graesser—‘Is it an Agent, or just a Program? A Taxonomy for Autonomous Agents—Proceedings of the Third International Workshop on Agent Theories, Architecture and Languages, Springer-Verlag, 1996.).

In a preferred embodiment an autonomous software agent or agents employed in conjunction with the present invention may utilise as a resource a machine learning work bench such as the WEKA utility tool set (http://www.cs.waikato.ac.nz/ml/weka/). All or part of such tools may be embodied or embedded in application software to be run on a computer system or systems located at the implementation site involved.

Preferably the computer executable code or software employed to provide an autonomous agent may be implemented in a platform independent manner. For example, such code or instructions may be written in a platform neutral language such as Java which if necessary may be compiled to binary form at an installation site by the computer platform on which such software is to be used.

Reference in general throughout this specification will also be made to the present invention employing a single autonomous software agent only in the implementation and operation of the prediction system to be provided. However, those skilled in the art should appreciate that multiple agents may be employed in alternative embodiments.

Preferably the configuration file prepared and used by such an autonomous agent may specify a number of different components to be implemented to provide the prediction system. Those skilled in the art should appreciate that a range of different types of building block or modular form components may be specified within a configuration file depending on the objectives or tasks to be set for the prediction system.

In some embodiments an agent may be employed to implement a data input interface as part of the prediction system. Such an input interface may provide a link to a data source or a data store to facilitate the transfer of data to other components of the prediction system. For example, in some instances a data interface component may connect to an existing database provided at an implementation site. Such an input interface may, for example, submit SQL queries to a database to retrieve data on demand as required by the prediction system. In other instances a data interface component may connect with a data logger or sensors (such as chemical analysis instruments), with collections of files on a computer hard disk, or with an Internet site which may supply captured data in real time, or off-line in batches to the prediction system. An input interface component may also connect to a storage buffer for such data, or alternatively may implement or include storage buffer facilities.

Those skilled in the art should appreciate that a data input interface element may also be configured to provide or facilitate access to both locally stored data or alternatively to remotely stored data which can be accessed via digital data transmission networks such as the internet. Such data input interfaces can supply the prediction system with a diverse range of data sourced from a number of potentially geographically separated yet logically connected sources. Primarily the data of most importance to such prediction systems would be that housed or provided at the installation site, but such data input interfaces may provide access to remotely located data if of use.

Those skilled in the art should also appreciate that a prediction system provided by the present invention may also incorporate a plurality of data input interfaces if a number of distinct and separate information sources are to feed data to the prediction system. For example, in number of instances the prediction system may incorporate a data input interface for each distinct information source from which data is to be transferred. Furthermore, it is likely that most implementations of prediction systems will require data sourced from the implementation site at which the prediction system is to be employed. Such interfaces can allow for the collection of such data to an autonomously implemented and operated prediction system, without necessarily requiring expert personnel to travel to and work at the implementation site.

A prediction system preferably also includes at least one predictive model. Such predictive models can be constructed using data supplied by input interfaces and utilising a package of mathematical routines such as the Weka machine learning workbench. Such a package enables the construction of superior predictive models through the application of relatively complex mathematical algorithms such as support vector machines, regression trees, and neural networks. Additionally models may be composed of or also include appropriate meta-algorithms such as bagging, boosting and stacking, which again assist in the provision of superior predictive models. Such predictive models may be created by the autonomous software agent using a collection of stored data provided at or by the implementation site. Stored data may, for example, provide both a training data set and test data set to allow for the subsequent construction and validation of a model. Preferably the software agent employed to create one or more models will also be tasked with the assembly and structuring of such training and test data sets to ensure that accurate predictions may be provided in future.

In a preferred embodiment a predictive model may also be modified over time in an iterative manner by a software agent as additional relevant data becomes available to the prediction system.

In some embodiments an agent may be employed to implement a prediction output interface for the prediction system. Such an output interface may be employed to take the results generated by one or more prediction models of a system and subsequently deliver these results to an end user. Such an output interface may, for example, write such results to a computer file, in addition to or alternatively visually or graphically displaying such results by hardcopy print outs or displays on a computer monitor.

In some embodiments an agent may be employed to implement a performance monitoring component as part of the prediction system. Such a performance monitoring component may collate predictions of the system with external validation data to provide model validation measurements. Such external validation data can be sourced from separate measurement or analytical processes to assess the accuracy of predictions made by the system either currently or historically. A monitoring component may for example implement an error threshold test when comparing actual measurements against predictions made. If such an error threshold is exceeded this will indicate that the prediction system performance may need to be reassessed and potentially the system may need to be reconfigured through the provision of a new configuration file.

Preferably, a predictive model integrated into the prediction system provided may be iteratively modified over time by a software agent or software agents as additional data becomes available to the system. This iterative modification may be completed to preferably improve the accuracy or results provided by the prediction system—with new data giving feedback as to whether previous predictions of the system were on target.

In a preferred embodiment an autonomous software agent may reside in either a prediction state or a training state. In a prediction state such an agent may operate to run the prediction system to ultimately provide predictions via an output interface. In a training state the agent may operate to build or rebuild one or more components of the system, usually including at least one predictive model.

In a further preferred embodiment an autonomous software agent may change from a prediction state to a training state based on the output of at least one performance monitoring component. These performance monitoring components can provide indications as to whether the predictions made by the system are acceptable or accurate enough for the application in which they are being used. If the predictions made are found to be lacking, the performance monitoring component may trigger a state change for an autonomous agent, and in turn trigger the rebuilding or re-training of at least one predictive model integrated into a prediction system.

However, those skilled in the art should appreciate that a predictive model may be iteratively modified over time by a software agent as additional data becomes available, and not necessarily just through the action or output of a performance monitoring component. For example, in alternative embodiments the availability of data which may be used as a training data set can trigger a state change in an agent from prediction to training if required.

The present invention may provide many potential advantages over the prior art.

The present invention allows for the implementation and operation of a prediction system at an implementation site without necessarily requiring the attendance of an expert designer on site. Such expertise may be employed remotely to prepare a configuration file which specifies the components and operational specifics of the prediction system, which in turn may be deployed and managed by an autonomous software agent or agents at the implementation site.

The use of such autonomous software agents allows prediction systems to be deployed by end users who need not necessarily have any knowledge of the mathematical disciplines and computer software which are normally required to effectively build and deploy complex predictive models. Furthermore, such autonomous software agents can remain resident as part of the prediction system both to manage the operation of a system to provide predictions, as well as to monitor and improve the accuracy or validity of such predictions over time.

The present invention may facilitate access to complex predictive models for relatively small organisations or entities which would not be able to afford to engage the services of the expert otherwise required. The present invention can be employed to eliminate any need for such an expert to physically travel to a user's site, simply requiring an expert to deliver an appropriate prediction system design through a configuration file—potentially from any geographic location.

### BRIEF DESCRIPTION OF DRAWINGS

Further aspects of the present invention will become apparent from the following description which is given by way of example only and with reference to the accompanying drawings in which:

FIG. 1 illustrates a schematic flow chart of steps executed to implement a prediction system in accordance with one embodiment of the present invention,

FIG. 2 illustrates a schematic flow chart of the two states that a prediction system can switch between in accordance with one embodiment of the present invention, and

FIGS. 3a, 3b illustrate an annotated excerpt from a sample configuration file specifying components of the prediction system discussed with respect to FIG. 1.

### BEST MODES FOR CARRYING OUT THE INVENTION

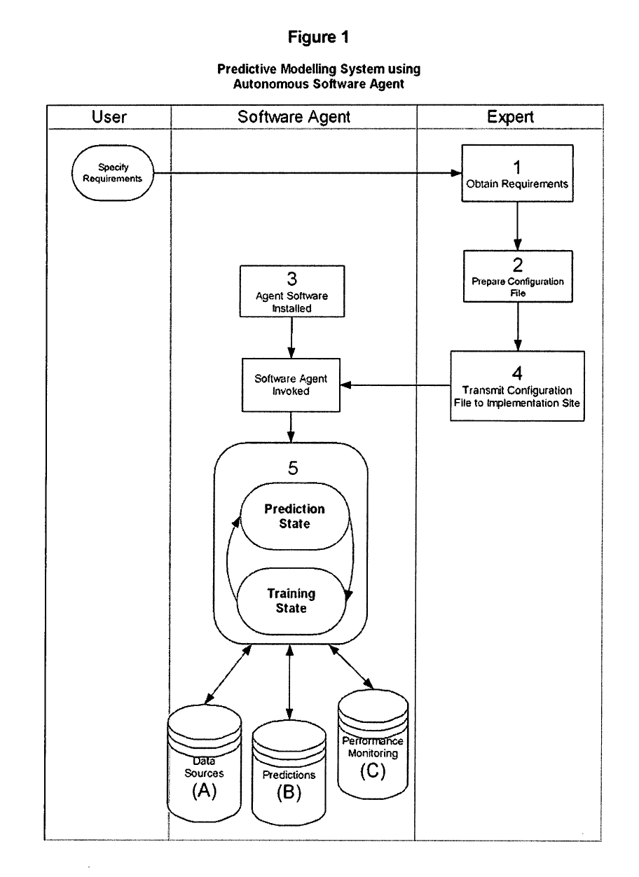

FIG. 1 illustrates a schematic flow chart of steps executed to implement a prediction system in accordance with one embodiment of the present invention.

This process starts at stage (1) when an expert is engaged to design a prediction system for a specific installation site, and becomes conversant with the particular requirements of the users of the prediction system. The expert engaged for this task will generally have high levels of experience in predictive modelling disciplines and also in the field in which the predictive system is to be employed at the implementation site.

At stage (2) the expert combines knowledge of these users' requirements with his or her expertise to prepare a single digital configuration file. This configuration file specifies the most appropriate components of the prediction system to be created and operated by the autonomous software agent, and the interactions between these components. At this stage (2) the expert may also prepare one or more predictive models for the autonomous software agent to use in its initial predictive mode.

At stage (3), which may precede or be concurrent with stage (2), the software to create the autonomous agent, and other software resources that the autonomous agent will require, are installed on a computer at the implementation site.

At stage (4) the configuration file, together with any initial models that might have been prepared by the expert, is transmitted from the location of the expert to the installation site and used to invoke the autonomous software agent. At this initialisation stage the autonomous agent is created in computer memory, equipped with all the components that the expert author has specified that it should use. These components may include data input interface components to provide the prediction system with access to data supplied from data sources (A), components for creating new predictive models prediction output components (B), performance monitoring components (C), and various utility components for tasks such as archiving historical data.

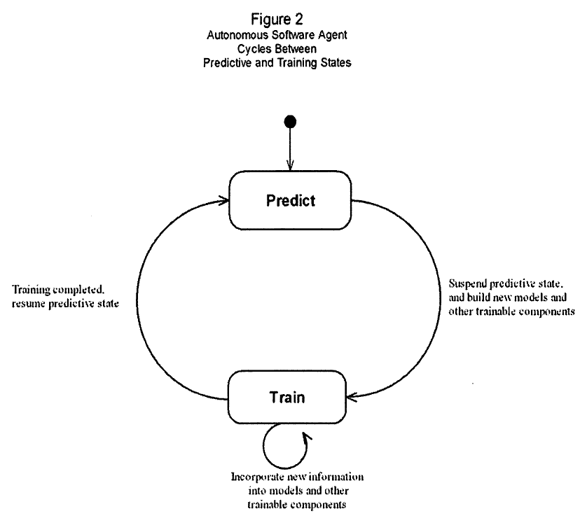

Next at stage (5, and FIG. 2) the autonomous software agent enters a persistent execution cycle. In this cycle the agent alternates between two states. In its prediction state it gathers new data, generates and publishes prediction results using whatever predictive models that it currently has available, monitors the performance of predictive models, and undertakes all other operations required to operate the prediction system and maintain its integrity. In training state, the above prediction state activities may be suspended, and the agent attends to the construction or reconstruction of all trainable components of the prediction system, including the predictive models themselves. It should be noted that many components of the prediction system other than the predictive models may be “trained”. These other components may access new data and in the process “learn” information that can be subsequently applied in the operation of the predictive system.

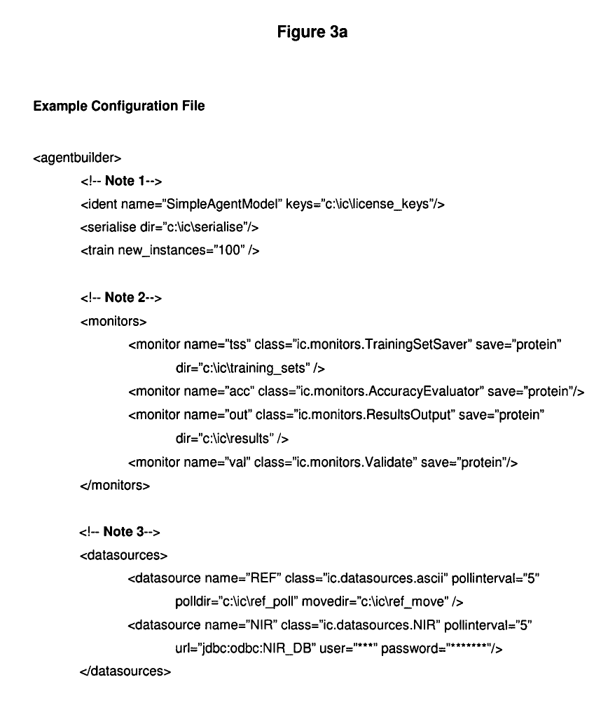

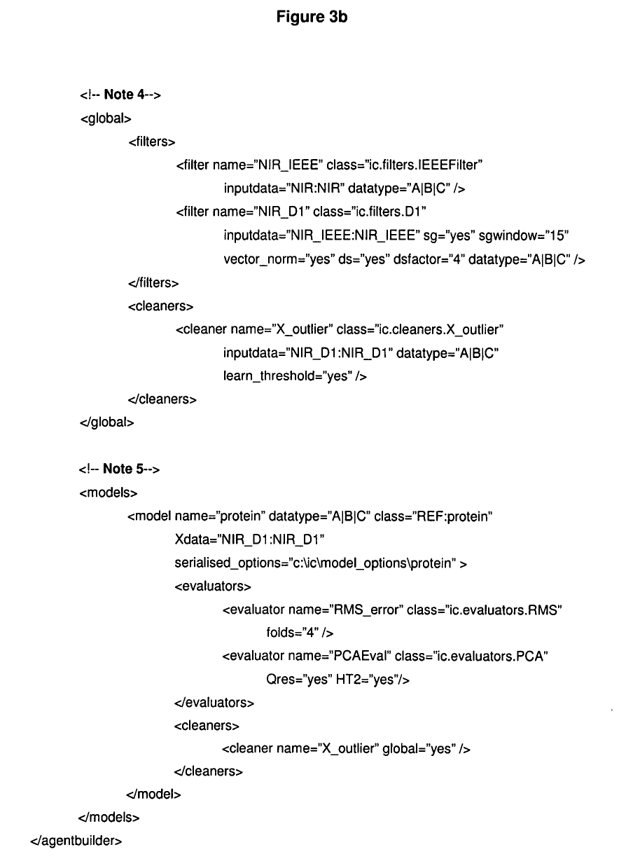

FIGS. 3a and 3b illustrate a sample configuration file specifying components of the prediction system implemented as discussed with respect to FIG. 1. As can be seen from these figures a series of comment points (note 1-note 5) are discussed further below.

Note 1

This XML formatted data gives a simple example of a configuration file that provides an autonomous agent with instructions for building, maintaining, and monitoring one predictive model for “protein” in samples of type ‘A’, ‘B’, or ‘C’.

The top level information gives a path to software license information, a path to use in serialising binary data, and an instruction to initiate model rebuilding whenever a threshold number of new data instances are available.

Note 2

The tools and parameters for several ancillary functions are indicated as “monitor” components. As necessary these will carry out the functions of saving training sets, evaluating the accuracy of model predictions, outputting results to a database, and carrying out a validation process on rebuilt models.

Note 3

Two independent, asynchronous data sources are specified, one as an ASCII file stream, another as a Universal Resource Locator for a database. These both poll for new data at 5 second intervals.

Note 4

A number of “global” resources are specified—these are resources that are available to carry out processes of data transformation and preparation. There are two “filters” and one “cleaner”. The first of the filters carries out an IEEE754 transform on data collected by the “NIR” data source, the other takes the output of this filter and performs a “1^{st} derivative” transform (using the Savitzky-Golay algorithm and a 15-point window) followed by vector normalisation and factor 4 down-sampling.

The “cleaner” named “X_outlier” takes the data produced by the filter chain above, and screens out any multivariate outliers using a “learnt” threshold.

Note 5

A model called “protein” is defined by giving the “class value” it is to predict (protein measurements collected by the instrument called “REF”) and the data to use as predictors (filtered data originally collected by the instrument called “NIR”). The mathematical algorithm and parameter settings to use are accessed from a disk file (“serialised_options”), and training sets built are to be “cleaned” using the X outlier cleaner.

The model contains two “evaluator components”. In generic terms, these components are resources constructed from the parent model training set that may be used to provide some insight into the performance of the parent model in either the training phase or the prediction phase.

In the example given, an “RMS evaluator” component will store the Root Mean Square error calculated from 4-fold cross-validation (at the end of the training phase). During the prediction phase, a “PCA evaluator” will generate X-outlier statistics (in this case, “Q residuals” and Hotelling's T² by projecting new instances onto a Principal Components model of the training set.

Aspects of the present invention have been described by way of example only and it should be appreciated that modifications and additions may be made thereto without departing from the scope thereof as defined in the appended claims.

What we claim is:

1. A method of implementing a prediction system characterised by the steps of;
i) preparing a configuration file, said configuration file specifying interactions to be completed between components of a prediction system, and
ii) transmitting said configuration file to an implementation site, and
iii) supplying the configuration file as an input to at least one autonomous software agent, wherein said agent or agents run the components of a prediction system as specified by the interactions defined within said configuration file.

2. A method of implementing a prediction system as claimed in claim 1 wherein the interactions defined by a configuration file specify messages, requests, commands and/or data to be passed between components of the prediction system when the prediction system is operating.

3. A method of implementing a prediction system as claimed in claim 1 wherein the configuration file specifies the components of the prediction system to be implemented.

4. A method of implementing a prediction system as claimed in claim 3 wherein a configuration file is transmitted to an implementation site, and a prediction system is subsequently built at this implementation site based on the components of the prediction system specified within the configuration file.

5. A method of implementing a prediction system as claimed in claim 1 wherein a digital signature is supplied in association with the configuration file.

6. A method of implementing a prediction system as claimed in claim 3 wherein components of the prediction system to be implemented include any combination of;
at least one data input interface,
at least one prediction output interface,
at least one predictive model,
at least one performance monitoring component.

7. A method of implementing a prediction system as claimed in claim 6 wherein an input interface provides a link to a data source facilitating data transfers to other components of the prediction system.

8. A method of implementing a prediction system as claimed in claim 6 which incorporates a data input interface for each distinct information source from which data is to be transferred.

9. A method of implementing a prediction system as claimed in claim 6 wherein a predictive model is created by an autonomous software agent using a collection of stored data provided at or by the implementation site.

10. A method of implementing a prediction system as claimed in claim 9 wherein stored data provides a training data set and a test data set.

11. A method of implementing a prediction system as claimed in claim 6 wherein a predictive model is iteratively modified over time by a software agent as additional data becomes available.

12. A method of implementing a prediction system as claimed in claim 6 wherein a performance monitoring component compares predictions made previously by the prediction system with external validation data.

13. A method of implementing a prediction system as claimed in claim 12 wherein external validation data is sourced from independent measurement or analytical processes.

14. A method of implementing a prediction system as claimed in claim 6 wherein an autonomous agent changes from a prediction state to a training state based on the output of at least one performance monitoring component.

15. A method of implementing a prediction system as claimed in claim 6 wherein a performance monitoring component implements an error threshold test.

16. Computer executable instructions configured to implement a prediction system at an implementation site, said instructions being configured to execute the steps of;
i) receiving a configuration file, said configuration file specifying interactions to be completed between components of a prediction system, and
ii) gathering data from at least one data source, and
iii) running the components of a prediction system as specified by the interactions defined within the configuration file using at least one autonomous software agent supplied with said gathered data.

17. Computer executable instructions as claimed in claim 16 wherein the interactions defined by a configuration file specify messages, requests, commands and/or data to be passed between components of the prediction system when the prediction system is operating.

18. Computer executable instructions as claimed in claim 16 wherein a digital signature is supplied in association with the configuration file.

19. Computer executable instructions configured to implement a prediction system at an implementation site, said instructions being configured to execute the steps of;
i) receiving a configuration file, said configuration file specifying the components of the prediction system to be implemented, and
ii) gathering data from at least one data source, and
iii) building the components of the prediction system specified within the configuration file, wherein data received from at least one data source is used to build at least one predictive model.

20. Computer executable instructions as claimed in claim 19 wherein a digital signature is supplied in association with the configuration file.

21. Computer executable instructions as claimed in claim 19 wherein components of the prediction system to be implemented include any combination of;
at least one data input interface,
at least one prediction output interface,
at least one predictive model,
at least one performance monitoring component.

22. Computer executable instructions as claimed in claim 21 wherein an input interface provides a link to a data source facilitating data transfers to other components of the prediction system.

23. Computer executable instructions as claimed in claim 21 which incorporate a data input interface for each distinct information source from which data is to be transferred.

24. Computer executable instructions as claimed in claim 21 wherein a predictive model is created by an autonomous software agent using a collection of stored data provided at or by the implementation site.

25. Computer executable instructions as claimed in claim 24 wherein stored data provides a training data set and a test data set.

26. Computer executable instructions as claimed in claim 21 wherein a predictive model is iteratively modified over time by a software agent as additional data becomes available.

27. Computer executable instructions as claimed in claim 21 wherein a performance monitoring component compares predictions made previously by the prediction system with external validation data to provide prediction model validation measurements.

28. Computer executable instructions as claimed in claim 27 wherein external validation data is sourced from independent measurement or analytical processes.

29. Computer executable instructions as claimed in claim 21 wherein an autonomous agent changes from a prediction state to a training state based on the output of at least one performance monitoring component.

30. Computer executables instructions as claimed in claim 21 wherein a performance monitoring component implements an error threshold test.
